(19) United States
(12) Patent Application Publication
(10) Pub. No.: US 2025/0370909 A1
(43) Pub. Date: Dec. 4, 2025

(54) OPTIMIZING MODEL SELECTION IN AGENTIC APPLICATIONS

(71) Applicant: Zeta Global Corp., New York, NY (US)

(72) Inventors: Zachary Jones, Decatur, GA (US); Danny Portman, Johns Creek, GA (US)

(21) Appl. No.: 19/228,703

(22) Filed: Jun. 4, 2025

Related U.S. Application Data
(60) Provisional application No. 63/656,040, filed on Jun. 4, 2024.

(51) Int. Cl. G06F 11/3604

(52) U.S. Cl. CPC G06F 11/3612

(57) ABSTRACT

The subject technology includes an optimization system for agentic applications. The optimization system may improve the performance of agentic applications by optimizing the language models selected for each tool included in the application. The language model selections determined by the optimization system may ensure each application tool is assigned a language model having capabilities and characteristics that align with the tool and the intended purpose and context of the application. The optimization system may also optimize one or more tunable model parameters of the selected language models to configure the selected language models for use in a particular agentic application. The optimization system may be trained using one or more machine learning techniques and may use one or more genetic algorithms to refine an initial set of application configurations determined by the system.

### PRIORITY CLAIM

This patent application claims the benefit of priority, under 35 U.S.C. Section 119(e), to Jones et al, U.S. Provisional Patent Application Ser. No. 63/656,040, entitled “OPTIMIZING MODEL SELECTION IN AGENTIC APPLICATIONS,” filed on Jun. 4, 2024 (Attorney Docket No. 4525.201PRV), which is hereby incorporated by reference in its entirety.

### TECHNICAL FIELD

The subject matter disclosed herein generally relates to the technical field of machine learning and, more specifically techniques for testing different configurations of machine learning and AI applications to improve application performance and minimize compute consumption.

### BACKGROUND

Language models including large language models (LLMs) and other forms of generative AI enable developers to create agentic applications that may assist humans with a wide range of tasks, including information retrieval, summarization, and acting on the user's behalf. To carry out these tasks, the applications are given access to a set of “tools”. The tools may be software components that can be invoked with a correctly formatted text string. Agentic applications may use language models to interact with the tools to complete various tasks.

The inventors here have recognized several technical problems with conventional agentic applications, as explained below. The rise in availability and popularity of language models has produced a diverse selection of models that could be used for each tool that an application might invoke. Currently, there are dozens of language models available, with each model having a unique interface and varying performance characteristics. For example, some language models are specialized for certain tasks, while others are designed for general use. Some language models offer very low latency, while others sacrifice latency for higher sophistication. The decision of which language model to use for a tool significantly affects the performance of agentic applications. For example, selecting an language model designed for general use to interact with a tool that requires a specialized language model may cause the application to fail to generate a response and/or generate an inaccurate or unhelpful response. Additionally, language models are complex machine learning models that may include millions, billions, and even trillions of trainable parameters. The complexity and size of these language models makes the models computationally intensive to train and inference. Due to the heavy compute requirements and high inference costs of language models, agentic applications may have to limit the number of requests users may submit and/or throttle the number of requests distributed to certain language models. A suboptimal selection of language models that occurs when an agentic applications selects a language model that has one or more characteristics (e.g., low latency, higher sophistications, and the like) that do not align with a tool may degrade the performance of the language model and cause the agentic application to consume more compute resources, have higher inference costs, and provide a poor user experience.

### SUMMARY

The application optimization system described herein improves the performance, speed, and reliability of agentic applications by optimizing the language models selected to invoke tools that agents use to perform tasks. The system includes a database of available language models and a unified interface for agentic applications to send requests to any of the available language models. The model database may include the capabilities and characteristics of each of the available models and the tasks each model is optimized to perform. The optimization system may also include a model selector that may select one or more language models that have the best fit for the tools used by agentic applications to perform each task. The model selector may also optimize one or more model parameters to tune the selected language model for a particular tool and/or task. The optimization system may also include a selection evaluator that may continuously refine the language model selection process by evaluating the performance of agentic applications that use the model selections determined by the model selector. The selection evaluator may mutate the language model selections determined by the model selector to create different language model configurations for agentic applications. The performance of the agentic application using each language model configuration may be determined and the highest performing configuration may be retrained for use in the agentic application.

### BRIEF DESCRIPTION OF THE DRAWINGS

Some embodiments are illustrated by way of example and not limitation in the figures of the accompanying drawings.

FIG. 1 is a block diagram illustrating a high-level network architecture, according to various embodiments described herein.

FIG. 2 is a block diagram showing architectural aspects of a learning module, according to various embodiments described herein.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

FIG. 5 depicts aspects of an implementation of one or more components of an application server, according to various embodiments described herein.

FIG. 6 depicts aspects of a learning module, according to various embodiments described herein.

FIG. 7 illustrates aspects of a training process for an optimization system, according to various embodiments described herein.

FIG. 8 illustrates aspects of a process for using an optimization system to improve the performance of a production version of an agentic applications, according to various embodiments described herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Agentic applications may be configured as software agents that can perform a variety of tasks across many industries. Agentic applications use one or more language models to invoke tools (e.g., APIs, scripts, programs, applications, data sources and other software components) to perform tasks in response to natural language requests submitted by users. Agentic applications may chain multiple tasks together to execute multistep workflows that may be required to perform complex tasks. The multistep workflows executed by agentic applications may be dynamically constructed by the agents and may include open ended tasks to provide a wide range of highly variable assistance to users. For example, an agentic application configured to perform as a data analyst can write scripts that invoke software tools used to retrieve data, perform data analysis, make predictions, and/or perform other subroutines required to generate results requested by the user. To execute each step in a multistep workflow, subroutines performed by agentic applications may select a language model and use the language model to generate natural language text to invoke and interact with one or more tools used to perform that step.

Agentic applications can increase efficiency and lower costs across many industries, but these applications are extremely expensive and compute intensive to operate. The compute load and cost of deploying agentic applications at scale requires agentic applications to be configured with some usage guardrails that limit the number of requests users can submit to agentic applications and/or throttle the volume of requests applications may submit to language models. The usage guardrails degrade the performance of agentic applications by increasing application latency and response times and expanding the number of failure instances where applications do not generate any response for a given user input. The usage guardrails also decrease the accuracy of the responses provided by agentic applications by forcing the applications to select language models that are unfit for particular tasks. The usage guardrails also diminish the reliability of agentic applications by creating long time periods where applications are unavailable or not working properly. Accordingly, there is a well established need for solutions that will improve the performance of agentic applications by increasing speed and reliability, while also reducing operating costs and improving user experience.

The technology described herein provides an application optimization system that improves the performance of agentic applications. The optimization system may be used to determine an optimal set of language model configurations that may be used by applications at runtime to reduce, application latency and drive down the operating costs and compute resources required by agentic applications. The model configurations may identify one or more language models that the agentic application may use to invoke the tools used by the application. The model configurations may also tune one or more parameters of the identified language models to improve the fit between the model and tool and maximize the performance of the model when interfacing with the tool. At runtime, the model configurations are used by the agentic applications to select an optimal language model for each subroutine of a workflow executed by the application. The language models to use for each subroutine may be selected from a library of available language models having diverse sets of characteristics and capabilities. The optimization system may provide a unified interface that agentic applications may use to send requests to each of the available language models. The optimization system may maintain a database of model data that includes a comprehensive set of characteristics, capabilities, performance metrics, and tool compatibility insights for each of the available models. Each set of model configurations determined by the optimization system may be mutated and each mutated variation may be tested to continuously refine the model selection process. The evaluation process performed by the application optimization system may improve the model configurations over time to maximize the application performance benefits provided by optimization system.

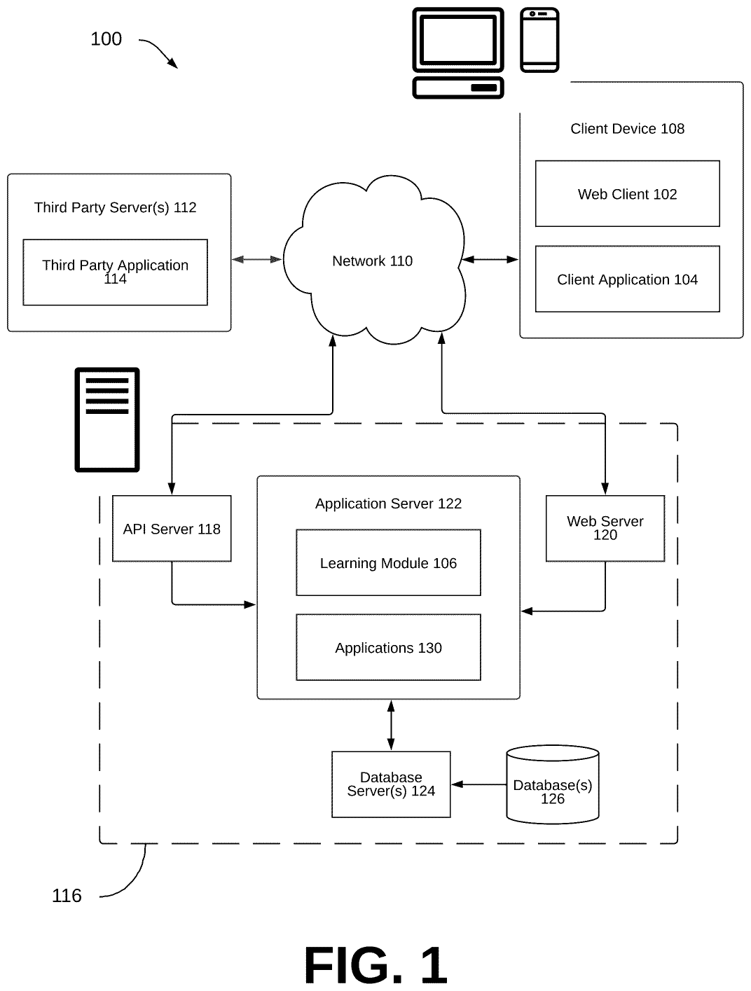

The optimization system may be implemented within a learning module included in the SaaS network architecture described in FIG. 1 below so that the model configuration functionality may be scaled within architectures that supports multiple available language models and multiple agentic applications. The SaaS network architecture also enables agentic applications configured by the optimization system to run on multiple client devices. With reference to FIG. 1, an example embodiment of a high-level SaaS network architecture 100 is shown. A networked system 116 provides server-side functionality via a network 110 (e.g., the Internet or WAN) to a client device 108 (e.g., an internet enabled device). A web client 102 and a programmatic client, in the example form of a client application 104, are hosted and execute on the client device 108.

The networked system 116 includes an application server 122, which in turn hosts one or more applications 130 (e.g., server side applications configured to provide functionality and/or content to end-user clients) that provide a number of functions and services to the client application 104 that accesses the networked system 116. The client application 104 may provide a number of graphical user interfaces (GUIs) described herein that may be displayed on one or more client devices 108 and may receive inputs thereto to configure an instance of the client application 104 and monitor operations performed by the application server 122. For example, the client application 104 may provide conversational user interfaces (UIs) interacting with agentic applications. To interact with agentic applications, users may enter request in the form of natural language prompts into the conversational UIs and content items including image data and natural language text generated by the agentic applications in response to requests may be displayed in the conversational UIs. The GUIs provided by the client application 104 may present outputs to a user of the client device 108 and receive inputs thereto in accordance with the methods described herein.

The client device 108 enables a user to access and interact with the networked system 116 and, ultimately, the learning module 106 or other applications 130 hosted by the application server 122. For instance, the user provides input (e.g., touch screen input or alphanumeric input) to the client device 108, and the input is communicated to the networked system 116 via the network 110. In this instance, the networked system 116, in response to receiving the input from the user, communicates information back to the client device 108 via the network 110 to be presented to the user.

An API server 118 and a web server 120 are coupled, and provide programmatic and web interfaces respectively, to the application server 122. The application server 122 hosts the learning module 106, which includes components or applications described further below. The application server 122 may also host one or more applications 130 that are linked to the learning module 106. For example, the application server 122 may host a publishing application that distributes one or more pieces of content including image data or other media generated by a generative system (e.g., a creative generation agentic application) included in the learning module 106. The application server 122 is, in turn, shown to be coupled to a database server 124 that facilitates access to information storage repositories (e.g., a database 126). In an example embodiment, the database 126 includes storage devices that store information accessed and generated by the learning module 106 and/or applications 130.

Additionally, a third-party application 114, executing on one or more third-party servers 112, is shown as having programmatic access to the networked system 116 via the programmatic interface provided by the API server 118. For example, the third-party application 114, using information retrieved from the networked system 116, may support one or more features or functions of a generative AI system, website, streaming platform, and the like hosted by a third party.

Turning now specifically to the applications hosted by the client device 108, the web client 102 may access the various systems (e.g., the learning module 106) via the web interface supported by the web server 120. Similarly, the client application 104 (e.g., an agent evaluation “app”) accesses the various services and functions provided by the learning module 106 via the programmatic interface provided by the API server 118. The client application 104 may be, for example, an “app” executing on the client device 108, such as an iOS or Android OS application, and/or a desktop application, web application, or other software application to enable a user to access and input data on the networked system 116 in an offline manner and to perform batch-mode communications between the client application 104 and the networked system 116.

FIG. 1 illustrates one embodiments of the network architecture 100 and other embodiments may include one or more other components and/or configurations. For example, one or more of the learning module 106 and/or applications may be hosted by its own server. Further, while the SaaS network architecture 100 shown in FIG. 1 employs a client-server architecture, the present inventive subject matter is of course not limited to such an architecture, and could equally well find application in a distributed, or peer-to-peer, architecture system, for example. The learning module 106 could also be implemented as a standalone software program, which does not necessarily have networking capabilities.

In various embodiments, the learning module 106 may include an application optimization system hosted by a optimization server. The optimization server may use the application optimization system to configure one or more agentic applications and/or language models to improve the performance of one or more agentic applications operated and managed by the application server 122. The optimization server may also test the performance of agentic applications configured by the application optimization system to determine the performance benefits provided by the agentic application and/or language model configurations and use the feedback to continuously improve the model selection process.

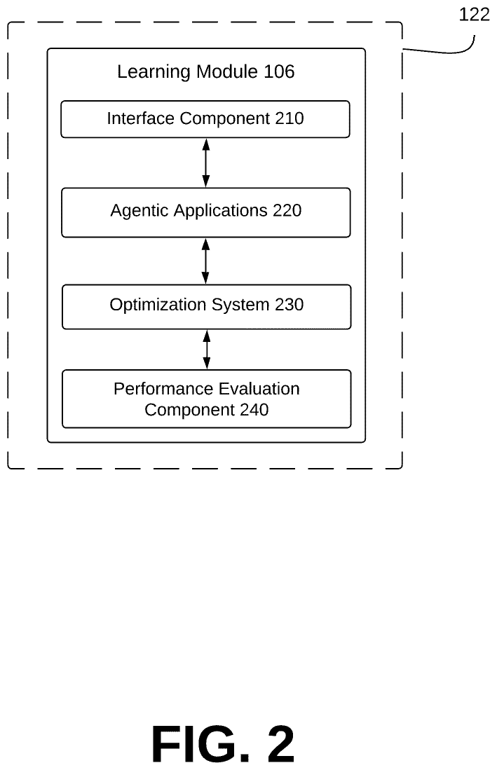

FIG. 2 is a block diagram showing architectural details of a learning module 106, according to some example embodiments. Specifically, the learning module 106 is shown to include an interface component 210 by which the learning module 106 communicates (e.g., over a network 110) with other systems within the SaaS network architecture of FIG. 1.

The interface component 210 may be coupled to one or more optimization components of one or more applications hosted by an application server. The optimization components may be linked to the optimization system 230 and/or evaluation component 240 via the interface component 210. The optimization components may operate the optimization system 230 and/or evaluation component 240 to provide specific aspects of optimizing and configuring one or more agentic applications 220 included in the learning module 106. The optimization components may display one or more evaluation user interfaces that may enable users to evaluate the performance of agentic applications optimized by the optimization system 230. For example, the evaluation user interfaces may provide one or more selectable and/or editable elements (e.g., buttons, drop down menus, sliding scales, text boxes, and the like) for users to rate the performance of the optimized agentic applications and provide specific feedback about aspects of the agentic applications that are performing well and aspects that are not performing up to expectations. The evaluation component 240 may use the feedback received from the evaluation user interfaces to further refine the model selection and model tuning processes performed by the optimization system 230.

The optimization system 230 may include a model selector that determines a language model agentic applications to use for each subroutine. The model selector may use machine learning techniques to evaluate all possible combinations of language models and tools to determine the optimal configuration of language models for each subroutine executed by an agentic application. The optimization system 230 may also include a tuning module that may use machine learning techniques to optimize one or more parameters of the language models selected by the model selector. The model selections and tuned model parameters determined by the model selector may be combined into a set of application configurations that are called by the agentic applications at runtime. The application configurations may improve the performance of the agentic applications by improving the accuracy and the quality of the responses generated by the agentic applications and reducing the costs and compute resources required to run the applications.

The evaluation component may use an application evaluator to improve the application configurations determined by the optimization system. The evaluation component may collect feedback on the agentic applications (e.g., user feedback, performance metrics, response scores, and the like) to determine how applications using different configurations are performing. Feedback collected by the evaluation component may also include one or more user actions recorded after a response from the agentic application was displayed to a user. For example, user actions including conversions (e.g., purchases captured in transaction data), clicks, impressions, page visits, online searches, requests submitted to agentic applications, and the like may be collected as feedback. The evaluation component may grade response generated by the agentic application as positive or negative based on the collected feedback. The grade, content included in the graded response, and the request submitted to the agentic application that the response was generated for may be included in a graded example that may be used to evaluate production versions of the agentic application.

The application evaluator may mutate the application configurations determined by the optimization system to determine multiple variations of application configurations (e.g., model selections, tool model mappings, model parameters, and the like). The performance of agentic applications configured with each of the mutated configurations may be evaluated based on the feedback collected by the evaluation component. The collected feedback may be used to train the application evaluator to determine the optimized application configurations for each agentic application. The evaluation component may run the application evaluator continuously, periodically on a regular schedule, and/or in response to specific triggers so that the optimized configurations are continuously refined and improved.

It should be understood that the learning module 106 may include one or more instances of each of the components. For example, the learning module 106 may include multiple sets of agentic applications 220 and/or multiple instances of the optimization system 230 and/or performance evaluation component 240 with each instance being operated to evaluate the performance of a different set of agentic applications 220.

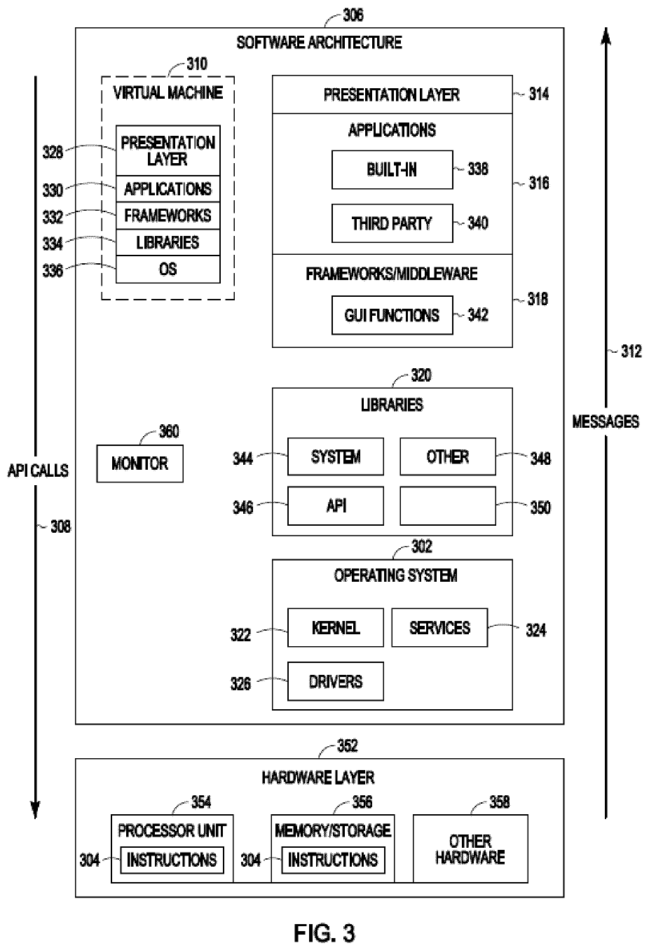

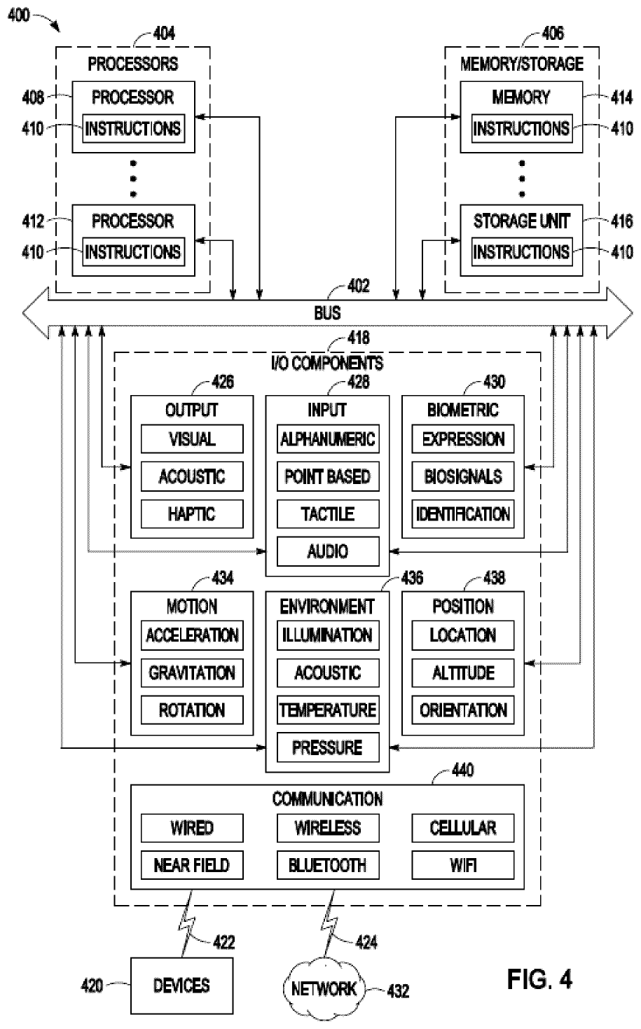

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and input/output (I/O) components 418. A representative hardware layer 352 is illustrated and can represent, for example, the machine 400 of FIG. 4. The representative hardware layer 352 includes a processor unit 354 having associated executable instructions 304. The executable instructions 304 represent the executable instructions of the software architecture 306, including implementation of the methods, components, and so forth described herein. The hardware layer 352 also includes memory and/or storage modules as memory/storage 356, which also have the executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the underlying operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of representative built-in applications 338 may include, but are not limited to, a contacts application, a browser application, a book reader application, a location application, a media application, a messaging application, a publishing application, a content application, a campaign configuration application, performance monitoring application, a scoring application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™ WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a non-transitory machine-readable medium (e.g., a non-transitory machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, non-programmed machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a single machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory, or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

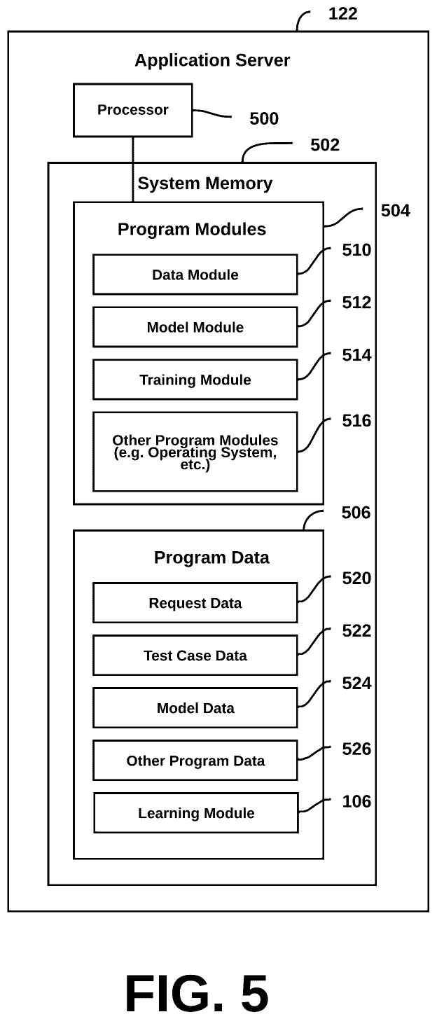

FIG. 5 illustrates an application server 122 hosting a learning module. The application server 122 may include at least one processor 500 coupled to a system memory 502 that may include computer program modules 504 and program data 506. In various embodiments, program modules 504 may include a data module 510, a model module 512, a training module 514, and other program modules 516 such as an operating system, device drivers, and so forth. Each module 510 through 516 may include a respective set of computer-program instructions executable by one or more processors 500.

This is one example of a set of program modules, and other numbers and arrangements of program modules are contemplated as a function of the particular design and/or architecture of the learning module. Additionally, although shown as a single application server, the operations associated with respective computer-program instructions in the program modules 504 could be distributed across multiple computing devices. Program data 506 may include data, program instructions, and other resources consumed by the program modules 504 to provide the functionality described herein. In various embodiments, program data 506 may include request data 520, model data 522, tools data 524, and other program data 526 such as data input(s), third-party data, and/or others. Program data 506 may also include instructions, data, and other resources used to implement the learning module described further below.

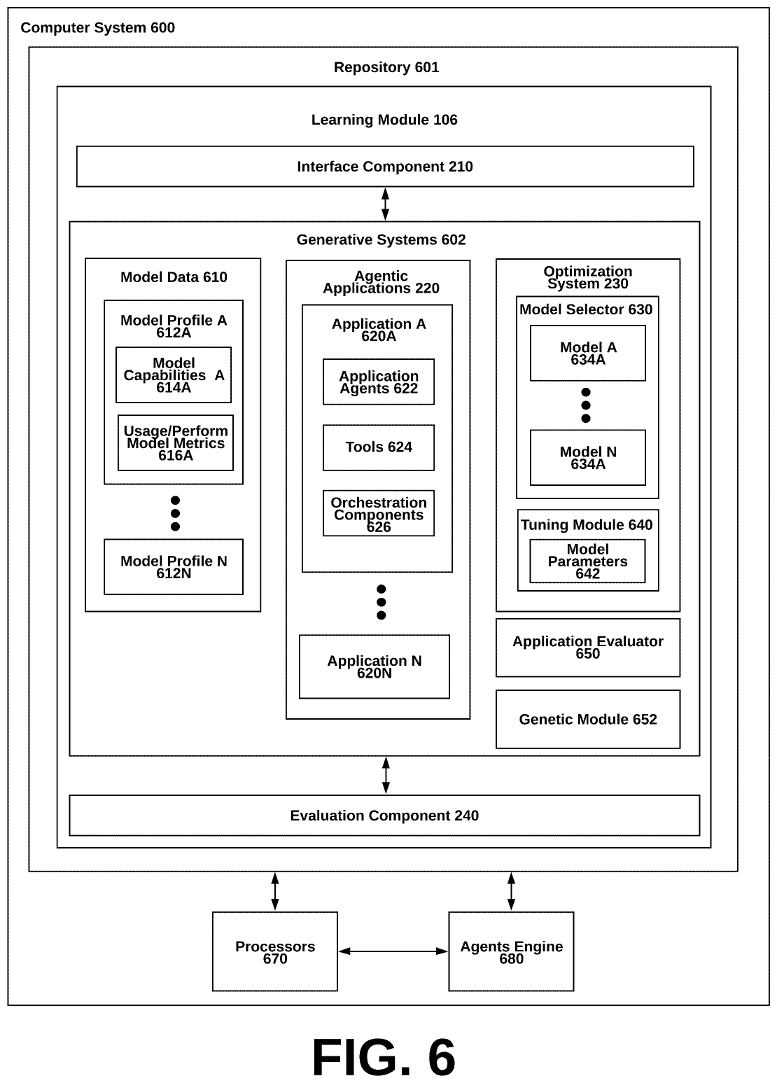

FIG. 6 is a block diagram illustrating more details of the learning module 106 in accordance with one or more embodiments of the disclosure. The learning module 106 may be implemented using a computer system 600 that may include a repository 601, an agents engine 680, and one or more computer processors 670. The computer system 600 may take the form of the application server 122 described above in FIG. 1 or any other computer including a processor and memory. The computer processor(s) 670 may take the form of the processor 500 described in FIG. 5.

The learning module 106 may include an interface component 210 connected to one or more generative systems 602. The interface component 210 may enable one or more applications hosted by the application server to interface with the generative systems 602 by, for example, sending requests (e.g., request messages formatted as language model prompts) to the generative systems 602 and receiving responses (e.g., completions generated by language models that are formatted as response messages) in return.

The learning module 106 may include an optimization system 230 that may improve the performance of one or more agentic applications 220 by optimizing the language models 634A, . . . , 634N used by the agentic applications 220. The optimization system 230 may include a model selector 630 that selects a language model 634A for the agentic application 220 to use to interact with one or more tools 624 and/or perform one or more intermediate steps. The optimization system 230 may also include a tuning module 640 that may optimize one or more model parameters 642 of the selected language models 634A, . . . , 634N for the agentic applications 220 and/or tools 624. The model selections and optimized model parameters 642 determined by the optimization system 230 may be aggregated into application configurations that are used by the agentic applications 220 at runtime. An evaluation component 240 may use an application evaluator 650 to test the application configurations against a population of mutated application configurations to improve the initial application configurations determined by the optimization system 230.

Agentic applications 220 configured by the optimization system 230 may include one or more application agents 622 that generate responses for tasks requested by users. The application agents 622 within each agentic application 620A, . . . , 620N may include AI agents that use language models or other generative AI to complete subroutines (e.g., action chains) required to perform tasks. An agentic application 620A may also include tools 624 (e.g., utilities, APIs, API wrappers, shells or terminals that execute commands written in a computer language (e.g., Python, Node.js, SQL), and the like) that may be used by the application agents 622 to complete subroutines. The tools 624 may provide an interface that enables the language models 634A, . . . , 634N selected by each agentic application 620A, . . . , 620N to interact with resources to perform the action and/or intermediate step (e.g., extract data, make a calculation, make a decision, execute a program, and the like) of each subroutine. The tools 624 may enable the language models 634A, . . . , 634N to interact with a wide variety of resources including, for example, data sources (e.g., relational databases, unstructured databases, identity graphs, document stores, and the like), software packages (e.g., applications, computer programs, executable files, executable programs, scripts, programs, code repositories, code libraries, and the like), content libraries (e.g., repositories of images, videos, audio files, and other content), and models (e.g., machine learning models, language models, generative AI, and other models that may generate predictions, make decisions, draw insights, perform data analysis, and generate other data).

An agentic application 620A may also include one or more orchestration components 626 that are used to run one or more plan and execution cycles required to complete each subroutine. During each plan and execution cycle, the orchestration components 626 may generate an agent call (e.g., a call to a language model) for an application agent 622. The agent call may include a language model prompt formatted for the language model 634A, . . . , 634N selected by the receiving application agent 622, a mapping between an action and/or intermediate step included in the language model prompt and a tool 624 that may be used to complete the action and/or intermediate step, and a software script for evoking and running the tool 624.

To perform a task such as, for example, proofreading a document, the agentic application 620A may receive a prompt including request to complete a proofreading task. A first application agent (e.g., a virtual assistant agent) may interpret the prompt and identify the proofreading task included in the user request. The orchestration components 626 may generate a first agent call that delegates the proofreading task to a second application agent (e.g., an editor agent). The first agent call may include a first prompt (e.g., instructions identifying the action and/or intermediate step for the agent to perform that may be formatted as natural language text) for the editor agent that instructs the agent to perform a first intermediate step (e.g., retrieve the document to proofread) of the proofreading task. The first agent call may also include a mapping between the document retrieval action and a document retrieval system. The first agent call may also include one or more lines of computer code (e.g., a software script) for invoking and using the tool to complete the action and/or intermediate step. For example, the first agent call may include an invocation script that may be used to locate the document retrieval system and authenticate into the system to access documents and a document search script that may be used to locate the requested document in the document retrieval system and open the document. To retrieve a document, the language model 634A for the editor agent may generate and pass natural language instructions to the tool identified in the first agent call. The identified tool may then use the scripts to operate the document retrieval system as specified in the in the first prompt and return the requested document to the editor agent.

Once the document is open, the orchestration components 626 may generate a second agent call for the editor agent. The second agent call may include a second prompt that instructs the editor agent to perform a second intermediate step (e.g., proofread the opened document). The second agent call may also include a mapping between the proofreading action and a proofreading software package and a script for invoking the proofreading package and operating the package to proofread the document. After the document is proofread, the orchestration components 626 may generate a third agent call that causes the editor agent to perform a third intermediate step (e.g., storing the proofread document and providing a copy of the proofread document to the virtual assistant agent). The orchestration components 626 may also generate a fourth agent call that causes the virtual assistant agent to perform a fourth intermediate step (e.g., providing the proofread document to the user and generating a summary of the errors that were discovered in the document).

To perform each intermediate step and/or action of a task, the application agents 622 may submit agent calls to different language models. The application agents 622 may execute one or more plan and execution cycles for each intermediate step and/or action, and the application agents 622 may select one or more language models to use for each cycle. During the plan phase of the cycle, the language models 634A, . . . , 634N selected by the application agents 622 may interpret the prompt included in the agent call to determine a next action and/or intermediate step to perform. For the execution phase, the language models 634A, . . . , 634N may use the tool mappings and scripts in the agent call to locate and interact with the one or more tools 624 to operate resources and perform the actions and/or intermediate steps. The selected language models 634A, . . . , 634N may generate a response including one or more outputs generated using the resources. The application agents 622 may receive the responses and include them in the next agent call for the next intermediate step. For example, the application agents 622 may include the response in an agent call for an agent that determines the next action and/or intermediate step required to from a task. The application agents 622 may also include the response in an agent call for an agent that performs a next action and/or intermediate step that may use and/or transform one or more outputs in the response. The plan and execution cycles for different agentic applications 220 may have different requirements that suit language models 634A, . . . , 634N with different performance characteristics and capabilities. For example, plan and execution cycles may involve different tools and different types of tasks that fit language models 634A, . . . , 634N having a particular performance profile.

Agentic applications 220 may be optimized for a wide range of tasks and industries that may have different risk profiles and cost constraints. Language models 634A, . . . , 634N having specific characteristics may be required and/or preferred for different tasks and industries. For example, agentic applications 220 for low-risk, low-complexity applications such as, for example, chatbots used for entertainment and/or informational purposes may prioritize the use of low latency and high efficiency language models to provide the most engaging user experience. The lower operating costs and high availability rates of these language models may be preferred over alternatives with higher standards of response accuracy and/or quality. Language models with different characteristics may be preferred for agentic applications 220 that handle moderate risk, moderate complexity tasks such as, for example, virtual assistants that may have access to some personal data and perform personalized tasks such as, for example, reviewing a user's email inbox to remind them of messages they have not responded to. Agentic applications 220 for medium-risk applications may prioritize the use of high security and smaller task specific language models over alternatives that provide lower latency and more general purpose functionality. Agentic applications 220 may also be built for high risk and high complexity applications such as, for example, medical diagnostic assistants that may interpret medical scans and/or patient data to diagnose medical conditions. Agentic applications 220 for high-risk applications may prioritize the use of large, fine-tuned, and task specific language models that deliver responses of the highest accuracy and quality over alternatives that may be smaller and easier to train and/or more cost efficient to inference and maintain.

The optimization system 230 described herein may generate a customized set of application configurations for each agentic application 620A, . . . , 620N. The customized application configurations may be tailored to the context (e.g., risk profile, nature of the tasks performed by the application, and the like), tools 624, and performance requirements of each application 620A, . . . , 620N. The application configurations may include one or more model selections determined by a model selector 630. The model selections may identify a language model 634A, . . . , 634N for each application agent 622 to use for each action and/or intermediate step of a task. The application configurations may also include a set of model parameters 642 that optimize the performance of each selected language model. The model parameters 642 may be determined by a tuning module 640 and may optimize each selected language model for its intermediate task to improve the performance of the selected language models 634A, . . . , 634N and applications 620A, . . . , 620N.

The model selector 630 may be a machine learning system trained to identity the optimal language model 634A, . . . , 634N for each tool 624 and/or intermediate step. The optimal model selections determined by the model selector 630 may be stored in the application configurations used by the agentic applications 620A, . . . , 620N at runtime. To determine the optimal model selections, the model selector 630 may use model data 610 to identify the available language models 634A, . . . , 634N that may be used by the agentic applications 220. The model data 610 may include a model profile 612A, . . . , 612N for each of the available language models 634A, . . . , 634N. The model profile 612A for each model may comprise one or more model capabilities 614A including the types of tasks the language model 634A may perform and the tools 624 that are compatible with the model 634A. The model profile 612A may also comprise one or more model metrics 616A including characteristics of the language model 634A (e.g., size, architecture, number of trainable parameters, composition of training data, tunable model parameters, fine-tuned model parameters, fine tuning tasks, composition of the fine tuning data, and the like) and performance metrics for training (e.g., training time, training cost, training compute, learning rate) and inference (inference time, inference cost, model perplexity, model accuracy, F1-score, ROUGE score, BLEU score, METEOR score, response metrics (e.g., question answering metrics, sentiment analysis metrics, named entity recognition metrics, and the like), task performance, and the like).

To train the model selector 630, training data for each agentic application 220 may be generated. The training data may be determined based on the tools 624 included in the application 620A and available language models 634A, . . . , 634N that may be used by the application 620A. The training data may include a model selection space that comprises each possible model selection for every application tool. For example, table 1 below displays the model selection space for an agentic application having three tools (e.g., tool 1, tool 2, tool 3) and three available language models (e.g. language model A, language model B, language model C).

TABLE 1

| | | |
|---|---|---|
| 1, A | 1, B | 1, C |
| 2, A | 2, B | 2, C |
| 3, A | 3, B | 3, C |
| 1, B | 1, A | 1, A |
| 2, A | 2, B | 2, A |
| 3, A | 3, A | 3, B |
| 1, C | 1, A | 1, A |
| 2, A | 2, C | 2, A |
| 3, A | 3, A | 3, C |
| 1, A | 1, B | 1, B |
| 2, B | 2, A | 2, B |
| 3, B | 3, B | 3, A |
| 1, A | 1, C | 1, C |
| 2, C | 2, A | 2, C |
| 3, C | 3, C | 3, A |
| 1, B | 1, C | 1, C |
| 2, C | 2, B | 2, C |
| 3, C | 3, C | 3, B |
| 1, B | 1, B | 1, C |
| 2, B | 2, C | 2, B |
| 3, C | 3, B | 3, B |
| 1, A | 1, B | 1, C |
| 2, B | 2, A | 2, A |
| 3, C | 3, C | 3, B |

One or more machine learning techniques may be applied to train the model selector 630 to determine the optimal model selections from the training data. For example, the model selector 630 may perform a constrained grid search over the space of possible language model selections to determine the optimal model selections for each agentic application 620A, . . . , 620N. To perform the constrained grid search, the model selector 630 may perform a first grid search over a first subset of the selections. For example, the model selector 630 may sample the selections having a particular model selected for one or more tools (e.g., tool A) to isolate a subset of selections that have the same model selected for the sampled tool(s) (e.g., tool A) and different models selected for the other tools (e.g., the non-sampled tools tool B and tool C). The model selector 630 may use an application evaluator 650 to generate a performance score for each set of selections in the first subset. The application evaluator 650 may generate the performance score by building different versions of the agentic application 620A configured with each of the different model selections and testing the different versions of the agentic application 620A on a set of test cases. The application evaluator 650 may include one or more evaluation agents (e.g., agentic applications) and/or evaluation language models trained to evaluate responses generated by agentic applications. The application evaluator 650 may generate performance scores for different model selections based on one or more performance metrics. The performance metrics may include a comprehensive set of evaluation criteria that assesses both the responses generated by agentic application (e.g., response metrics) and the performance of the agentic application during response generation (e.g., technical metrics). Some example response metrics are included in Table 2 below.

TABLE 2

| Response Metric | Definition |
|---|---|
| Conciseness | Measures the length of the response while |
| | ensuring the content remains relevant. |
| Relevance | Evaluates the extent to which the response |
| | addresses the user's query. |
| Correctness | Determines whether the information provided |
| | aligns with the facts of reality. |
| Coherence | Assesses the logical structure and flow of the |
| | response. |
| Harmfulness/ | Identifies any harmful or malicious content. |
| Maliciousness | |
| Helpfulness | Measures the usefulness of the response. |
| Controversiality | Detects any potentially polarizing content. |
| Misogyny, | Evaluates the response's adherence to ethical |
| Criminality, and | guidelines. |
| Ethics | |
| Semantic | Calculates the Levenshtein distance between |
| Similarity | the correct response and the application's |
| | output, as well as the distance between their |
| | language embeddings, providing a measure of |
| | similarity in meaning. |
| Overall Score | Combines all the preceding metrics into a single |
| | response score that may be weighted according |
| | to the evaluator's requirements. |

The model selector 630 may generate response scores for each configuration of the agentic application 620A (e.g., application versions configured with each of the model selections in the first subset) based on one or more response metrics determined for the sample of test cases. Each agentic application configuration may generate a response for each test case and the application evaluator 650 may determine response metrics for each response. The test cases may include example user requests that test the functionality of the agentic application 620A. For example, test cases for a proofreading agentic application may include request prompts that instruct the application to proofread documents of different languages, lengths, styles, subject matter, error counts, and the like. The application evaluator 650 may average or otherwise combine (e.g., use a weighted average calculated by determining weights each of the response metrics depending on the importance of the metric and averaging the weighted values for each metric) the response metrics for the responses for each test case to generate a response score for each application configuration and/or set of model selections used by the application configuration.

The model selector 630 may also determine one or more technical metrics that measure one or more aspects of the performance of the agentic application during response generation. Some example technical metrics that may be measured for responses generated by the agentic application are included in table 3 below.

TABLE 3

| Technical Metric | Definition |
|---|---|
| Response Time | Measures the amount of time required by the |
| | agentic application to generate a final response to a |
| | user request. |
| Latency Time | Measures the amount of time required by the |
| | agentic application to transition to the next |
| | subroutine. |
| Inference Cost | Measures the financial cost required to generate a |
| | final response to user request. |
| Number of | Identifies the number of subroutines required by the |
| Subroutines | agentic application to generate a final response to a |
| | user request. |
| Number of Agent | Identifies the number of agent calls required by the |
| Calls | agentic application to generate a final response to a |
| | user request. |
| Inference | Measures the amount of compute resources (e.g., |
| Compute | memory, processing power, electrical power, and |
| | the like) consumed during generation of a final |
| | response. |
| Overall Score | Combines all the preceding metrics into a single |
| | technical score that may be weighted according to the |
| | evaluator's requirements. |

The technical metrics determined for each application configuration during the generation of responses for each test case may be averaged or otherwise combined (e.g., combined using a weighted average calculated by determining weight for each of the technical metrics based on the importance of the technical metric and averaging the weighted values for each metric) to generate a technical score for the application configuration and/or set of model selections used by the application configuration. The model selector 630 may average or otherwise combine (e.g., using a weighted average) the technical score and the response score to determine a performance score for each of the application configurations and/or model selections in the subset.

The model selections in the first subset that generated the highest performance score may be used to identify the optimal model selections for the non-sampled tools (e.g., tool B and tool C). The model selector 630 may perform a second grid search to identify the optimal selection for the one or more sampled tools (e.g., tool A). The second gird search may be performed by fixing the models selected for the non-sampled tools to optimal selections identified by the initial grid search. The model selector 630 may search over the full set of possible model selections for the sampled tool(s) (e.g., tool A) by determining a second subset of model selections. Each set of model selections in the second subset may have the optimal model selections for the non-sampled tools and a different model selected for the sampled tool(s). The application evaluator 650 may determine response metrics and/or technical metrics for different configurations of the agentic application 620A (e.g., instances of the agentic application 620A using each of the model selections in the second subset) for each test case. The response metrics and/or technical metrics for each test case may be combed to generate response scores and/or technical scores for each application configuration have a different set of model selections. The response scores and/or technical scores may be combined to generate a performance score for each of the application configurations and/or model selections in the second subset used by each configuration. The model selector 630 may retain the model selections of the application configuration having the highest performance score in the second grid search as the optimal model selections for use in the agentic application 620A.

A tuning model 640 may run in parallel with the model selector 630 to optimize one or more model parameters 642 of the language models 634A, . . . , 634N selected by the agentic applications 620A, . . . , 620N. One or more machine learning techniques may be applied to train the tuning model 640. The training operations for the tuning model 640 and the model selector 630 may run in parallel so that both components are trained at the same time to minimize the number of training cycles and maximize the compute and cost efficiency of the training process for both components. In various embodiments, the tuning model 640 may perform a Bayesian optimization search (e.g., a sequential model-based optimization search (SMBO), constrained Bayesian optimization, multi-objective Bayesian optimization, asynchronous parallel Bayesian optimization, and the like) over one or more tunable model parameters 642 of the language models 634A, . . . , 634N included in the model selections evaluated during training of the model selector 630. For example, the tuning module 640 may be trained by performing an SMBO for temperature (e.g., the randomness and/or determinism of the model's output generation with higher temperatures leading to more diverse but potentially less coherent outputs, and lower temperatures resulting in more conservative but potentially less creative outputs), frequency penalties (e.g., penalties for generating repetitive content which can help avoid monotony in responses), presence penalties (e.g., penalties for generating content that has not been seen recently which can help ensure content is relevant), and/or other tunable model parameters 642.

To train the tuning module 640 using an SMBO, random values for temperature, top-k sampling, top-p sampling, repeition penalties, beam search width, max tokens and/or other tunable model parameters may be selected from a uniform distribution (e.g., between 0.0 and 0.1). The random values may be assigned randomly to the language models 634A, . . . , 634N included in each set of model selections in the subset of selections evaluated in the constrained gird search. A surrogate model (e.g., a random forest regression, Gaussian process, and the like) may be used to determine the values for the model parameters that have potential to increase the performance scores for the model selections. The surrogate model may be trained using the performance scores for the model selections in the first subset. The surrogate model aims to predict the performance of the agentic application 620A when using a given language model configured with a given set of model parameters 642.

Once trained on the performance scores, the surrogate model may be used to identify areas of the parameter space that include promising values for one or more tunable parameters. An acquisition function (e.g., probability of improvement, expected improvement, Bayesian expected losses, upper confidence bounds or lower confidence bounds, Thompson sampling, and the like) that balances exploration (e.g., trying new parameters) and exploitation (e.g., focusing on parameters in the most promising areas of the parameter space) may be used to select parameter values from the most promising areas of the parameter space identified by the surrogate model. The selected parameter values may be assigned to the language models 634A, . . . , 634N in the model selections of the second subset. Performance scores for application configurations having different model selections and different parameter values for each of the selected models may be determined by the application evaluator 650 and the tunable parameters of the configuration with the highest performance scores may be stored and used in the agentic application.

The performance scores for the model configurations and values of the tunable parameters of the selected models in each configuration may be stored and used to retrain the surrogate model at the end of each iteration of the constrained gird search. For example, the performance scores for the first subset of model selections may be used to train the surrogate model that identifies the promising parameter values for the language models 634A, . . . , 634N in the model selections of the second subset of selections and so on. In various embodiments, it may take two or more iterations of the parallel constrained gird search and SMBO to determine the optimal model selections and tunable parameters for an agentic application 620A. For each iteration of the constrained grid search, the surrogate model may be updated using the performance scores from the previous iteration. For example, the surrogate model may be retrained using the model selections, parameter values, and performance scores of each application configuration. The updated surrogate model may select new areas of the parameter space to evaluate and the acquisition function may select new parameter values from these regions for each model identified in a subset of model selections evaluated in a constrained grid search. New iterations of the parallel constrained grid search and SMBO may be performed until a maximum value for the performance scores and/or a value for the performance scores that meets and/or exceeds a performance threshold is achieved. The model selections and model parameters 642 for the application configuration having the highest performance score may be retained as the optimal application configurations to use in the agentic application.

To ensure the optimal application configurations are up to date and continuously improved, the model selector 630 and tuning module 640 may be retrained by performing additional iterations of the parallel constrained grid search and SMBO in response to one or more triggering events. For example, model selector 630 and tuning module 640 may retrained in response to a change in the available language models (e.g., a new model, an updated model, the removal of a model, and the like) and/or a change to the agentic application 620A (e.g., changes to application tools 624, changes to application test cases, changes to application performance constraints, and the like). The model selector 630 and tuning module 640 may also be retrained periodically on a predetermined schedule.

The optimal application configurations may be applied to published agentic applications so that the published applications may use the optimal configurations at runtime. The optimal application configurations determined by the optimization system 230 are determined using machine learning techniques that predict how agentic applications will perform in production based on how well the agentic application performs in test environments (e.g., the performance of the agentic application across a sample of test cases). To maximize the application performance and user experience of agentic applications in production environments, the model selector 630 may be retrained using one or more genetic algorithms. The retraining process may refine the initial optimal application configurations based on user feedback and/or technical metrics measured for the published applications. For example, different configurations of the published agentic applications may be tested on actual user requests and the responses generated by each application configuration may be tested against example responses that were graded by users. The genetic algorithms may use one or more genetic operators to modify the optimal application configurations to create test sets of mutated configurations. The responses generated by configurations of the agentic applications having each set of mutated configurations may be tested on a sample of graded responses to determine a fitness score for the mutated configurations. The technical performance of the agentic applications configured with each set of mutated configurations may also be tested against one or more performance metrics measured during the generation of the graded responses to determine an efficiency score for the mutated configurations. The application evaluator 650 may then use the fitness score and/or efficiency score to determine a set of production configurations to use for each agentic application.

To generate the test sets of mutated configurations, a genetic module 652 may determine a genome for the optimal configurations. The genome represents the optimal configurations for an agentic application as a string of characters. Each character in the genome may signify the assignment of a specific language model to one or the applications tools and/or intermediate steps. For example, an agentic application may have access to three different language models, each of which may be represented by an alphabetic character (e.g., LM 1—“a”, LM 2—“b”, LM 3—“c”). Suppose the agentic application also has and four tools, each of which uses a language model, the genome for the application may include four elements (e.g., have a length of four characters) with each element signifying the assignment of a language model to one of the four tools. For example, the genome “aaaa” may represent the assignment of LM 1 to each of the four tools. The genome “cbab” may represent the assignment of LM 3 to the first tool, LM 2 to the second tool, LM 1 to the third tool, and LM 2 to the fourth tool. The genetic module 652 may determine a unique genome for each agentic application based on the language models selected for each of the tools and/or intermediate steps in the optimal configurations.

The genetic module 652 may mutate the genome representing the optimal configurations to determine a population of N mutated genomes (where N represents a predetermined number, e.g., 10, 100, 1000, and the like). The genetic module 652 may generate each mutated genome by duplicating the genome representing the optimal configurations N times and introducing random replacement mutations in each copy. The random replacement mutations may substitute one or more model selections in the genome with a different model selected randomly from the available models. For example, a mutated genome for the application genome “cbab” may be “cbbb”. The genetic module 652 may mutate the genome representing the optimal configurations by inserting random replacement mutations into each copy of the original genome until a population of mutated genomes of the desired size is produced.

To retrain the model selector 630, application configurations having model selections represented by each of the mutated genomes may be evaluated on a sample of graded examples to determine the fitness of each mutated genome. The graded examples may include agentic application responses that were evaluated by users. For example, the graded examples may include responses to user requests that received positive or negative user feedback. In various embodiments, the user feedback may be collected in a UI of the agentic application and/or publishing system or other application that provides users with responses generated by the agentic application. The UI may have one or more elements (e.g., buttons, selections, sliders, or other objects) for entering feedback, for example, a thumbs-up element for entering positive feedback and a thumbs-down element for entering negative feedback. The UI may collect the user feedback for a response and store the user request, the response (e.g., the graded example), and the feedback for the response in a test dataset for the agentic application. The graded examples in the test dataset may be generated by the agentic application configured with the optimal configurations determined by the optimization system 230.

To compare the responses generated by configurations of the agentic applications having the mutated configurations to the graded examples, the application evaluator 650 may extract a test set of graded examples and the corresponding user request for each example from the test dataset. The application evaluator 650 may set the fitness score for each mutated configuration to 0 and iterate over each graded example, in the test set. For example, the application evaluator 650 may execute an agent call that displays each user request in the test set to configurations of the agentic applications having different mutated configurations (e.g., a version of the agentic application having each of the mutated configurations) and generate a response. The response from each version of the application may be compared to the graded example by calculating a cosine similarity between the generated response and the graded example. To determine the cosine similarity, the application evaluator 650 may convert the text of the generated response and the graded example into a numerical vector representation using a text to vector algorithm (e.g., bag-of-words, tf-idf, and the like) and/or the word embeddings calculated by the language models of the agentic application. The application evaluator 650 may then determine the cosine similarity between the generated response vector and the graded example vector.

For graded examples that received positive user feedback (e.g., a selection of a thumbs-up element), the cosine similarity for the generated response and graded example vectors may be added to the fitness score. For graded examples that received negative user feedback (e.g., a selection of a thumbs-down element), the cosine similarity for the generated response and graded example vectors may be subtracted from the fitness score. This manner of determining the fitness score gives higher fitness scores to mutated configurations that generate responses that are similar to graded examples with positive feedback and different from graded examples with negative feedback. The fitness score for each mutated configuration may be the final sum of the cosine similarities determined for each graded example.

The model selector 630 may also be retrained based on the performance of the agentic application during the process of generating responses (e.g., the efficiency, speed, reliability, and the like of the application when performing the operations required to generate responses). To retrain the model selector 630, the application evaluator 650 may measure one or more performance metrics (e.g., response time, latency time, inference compute, inference cost, and the like) for the agentic application having the optimal configurations during the generation of each graded example. The performance metrics may be stored in the test dataset and compared to performance metrics measured for a version of the agentic application having each of the mutated configurations. For example, the application evaluator 650 may measure the percent difference between one or more performance metrics measured for versions of the agentic application having the mutated configurations and one or more performance metrics measured for the agentic application with the optimal configurations during the generation of each generated response and graded example response respectively.

The application evaluator 650 may determine an efficiency score for each mutated configuration based on a combination of the cosine similarity and percent difference calculated for the one or more performance metrics. For example, the application evaluator 650 may use cosine similarity to select a number of responses and/or graded examples where application configurations having the mutated configurations performed well (e.g., generated response that were similar to graded examples that received positive user feedback). To select the responses to use for determining the efficiency score, the application evaluator 650 may identify the graded examples in the test dataset that received positive user feedback and determine the cosine similarity of the generated response for each positive graded example. The cosine similarity for each selected generated response may be compared to a predetermined similarity threshold (i.e., e.g., 0.7 or above). If the cosine similarity for the selected generated response is at or above the similarity threshold, the performance metrics measured for the graded example may be extracted from the test data and the performance metrics measured for the selected generated response may be stored. The percent differences between the one or more performance metrics measured during generation of each generated response meeting the similarity threshold and the one or more performance metrics measured during generation of the corresponding graded example may be calculated. The calculated percent differences determined for each selected graded example and corresponding generated response may be averaged to determine the efficiency score for each mutated configuration. This manner of determining the efficiency score gives higher efficiency scores to mutated configurations that had a higher performance (e.g., greater positive percent difference) for one or more performance metrics when generating responses that are similar to graded examples with positive feedback. The efficiency score may be used to determine the fitness score for the mutated configuration. For example, the efficiency score and initial fitness score determined from the cosine similarities may be averaged, combined using a weighted average (e.g. a weighted average determined using a weight (e.g., 0.3) for efficiency score and a weight (e.g., 0.7) for initial fitness score), or otherwise combined to determine a composite fitness score for the mutated configurations. The composite fitness score may account for both the accuracy and quality of the responses reflected in the initial fitness score and the performance of each application configuration during response generation reflected in the efficiency score.

The retrained model selector 630 may determine a set of production configurations based on the fitness scores and/or composite fitness scores of the mutated configurations. For example, the model selector 630 may select the mutated configuration having the highest fitness score and/or composite fitness score as the production configurations that may be used by the agentic application. The optimization system 230 may replace the optimal configurations with the production configurations and agentic application may use the production configurations to generate responses to user requests. A second retraining step may also be performed to improve the production configurations determined by the model selector 630.

To perform the second retraining step, the genetic module 652 may select a predetermined number of mutated genomes (e.g., 10, 100, 1000, M, and the like) that received the highest fitness scores and/or composite fitness scores determined during the first retraining cycle for the model selector 630. The selected mutated genomes may be further mutated to create a population of a predetermined number (e.g., 10, 100, 1000, C, and the like) of child genomes. The genetic module 652 may create the child genomes by mutating copies of the selected mutated genomes using one or more genetic operators (e.g., alternating-positions crossover, swap-two mutation, and/or random replacement mutation) to create a population having the desired number of child genomes. The application configurations represented by the child genomes (e.g., the child configurations) may be tested by the application evaluator 650 to determine updated production configurations for the agentic applications 220.

To use the alternating-positions crossover operator to generate a child genome, the genetic module 652 may select the genomes having the top two fitness scores and/or composite fitness scores as the parent genomes. The genetic module 652 may alternately select elements from the parents to generate the child genome. For example, if “cabc” and “acab” are selected as the parent genomes, the first element from the genome with the highest fitness score (“cabc”) may be selected as the first element of the child genome, the first element from the genome with the next highest fitness score (“acab”) may be selected as the second element of the child genome and so on until all the elements in the child genome are filled. The genetic module 652 may use the alternating-positions crossover operator on the “cabc” and “acab” genomes to create a child genome of “caac”. The genetic module 652 may also create a second child genome (“bacb”) for these two parents by continuing to use the alternating-positions crossover operator on the third and fourth elements of each parent genome. The genetic module 652 may generate additional child genomes by selecting new parent genomes and repeating the operations of the alternating-positions crossover operator. For example, the genetic module 652 may select the genomes with the next highest fitness and/or composite fitness scores (e.g., the genomes with the third and fourth highest scores) as the new parent genomes. The genetic module 652 may also retain the original first parent genome (e.g., the genome with the highest fitness and/or composite fitness score) and select a new second parent genome having the next highest fitness score and/or composite fitness score (e.g., the genome having the third highest fitness and/or composite fitness score). The genetic module 652 may also select any combination of the mutated genomes as parent genomes and apply one or more genetic operators to create child genomes.

To use the swap-two mutation operator to generate a child genome, the genetic module 652 may select one parent genome (e.g., the genome having the highest fitness score and/or composite fitness score) and randomly select two elements within the parent genome to change. The genetic module 652 may then swap the language model selections in the selected elements to generate the child genome. For example, to use the swap-two mutation operator on a “cabc” genome, the genetic module 652 may randomly select the first and third elements and swap the language model selections in the elements to generate a child genome of “bacc”. The genetic module 652 may generate additional child genomes using swap-two mutation by randomly selecting any other two elements of the original parent genome to swap and/or selecting additional parent genomes and repeating the operations of the swap-two mutation operator described above. The genetic module 652 may also use the random replacement mutation operator described above on one or more of the selected mutated genomes to create child genomes.

The application evaluator 650 may evaluate the child application configurations represented by each of the child genomes by generating an instance of the agentic application configured with each set of child configurations (e.g., an agentic application having the model selections represented by each of the child genomes). The application evaluator 650 may determine a fitness score and/or composite fitness score for each of the child configurations using the evaluation process described above for the mutated configurations. The retraining process may be repeated for a predetermined number of steps (e.g., 10, 100, 1000, P, and the like) by selecting one or more child genomes (e.g., child genomes with the highest fitness scores and/or composite fitness scores), generating a next set of child genomes using one or more genetic operators, and evaluating applications configured using the model selections represented by the next child genomes. The child genome with the highest fitness score and/or composite fitness score after the final retraining step may be adopted as the final genome for the agentic application and the model selections of the final genome may be stored as the production configurations. The production configurations may be applied to the published agentic applications by replacing the optimal configurations determined by the optimization system with the production configurations. The production configurations may be used by the published agentic applications at runtime to improve the performance and/or user experience of the published applications.

The application evaluator 650 may evaluate the technical performance of and the responses generated by applications configured with the production configurations and compare the level of performance and generated responses to a baseline level of performance and generated responses produced by agentic applications configured with the optimal configurations. If the level of performance and/or generated responses observed for applications including the production configurations improves relative to the baseline performance and/or generated, the application evaluator 650 may confirm the production configurations as the configurations to use for the agentic application. If the level of performance and/or generated responses observed for agentic applications including the production configurations does not provide an improvement relative to the baseline, the application evaluator 650 may switch back to the optimal configurations and the agentic application may use the optimal configurations to generate responses to user requests.

The application evaluator 650 may continuously evaluate the performance of the agentic applications over time as new versions of the application are published and/or more user feedback is collected. The application evaluator may use the additional user feedback to retrain the model selector 630 by generating new test datasets including graded examples reflecting the additional user feedback and evaluating the responses generated by different application configurations (e.g., application configurations including mutated configurations) based on the new graded examples. Once retrained on the new graded examples, the model selector 630 may provide updated production configurations that may be applied to the agentic applications to improve the performance of and/or responses generated by the new versions of the published agentic applications. For example, the updated production configurations may optimize the agentic applications for new user requests, new language models, new tools and other new components of published agentic applications.

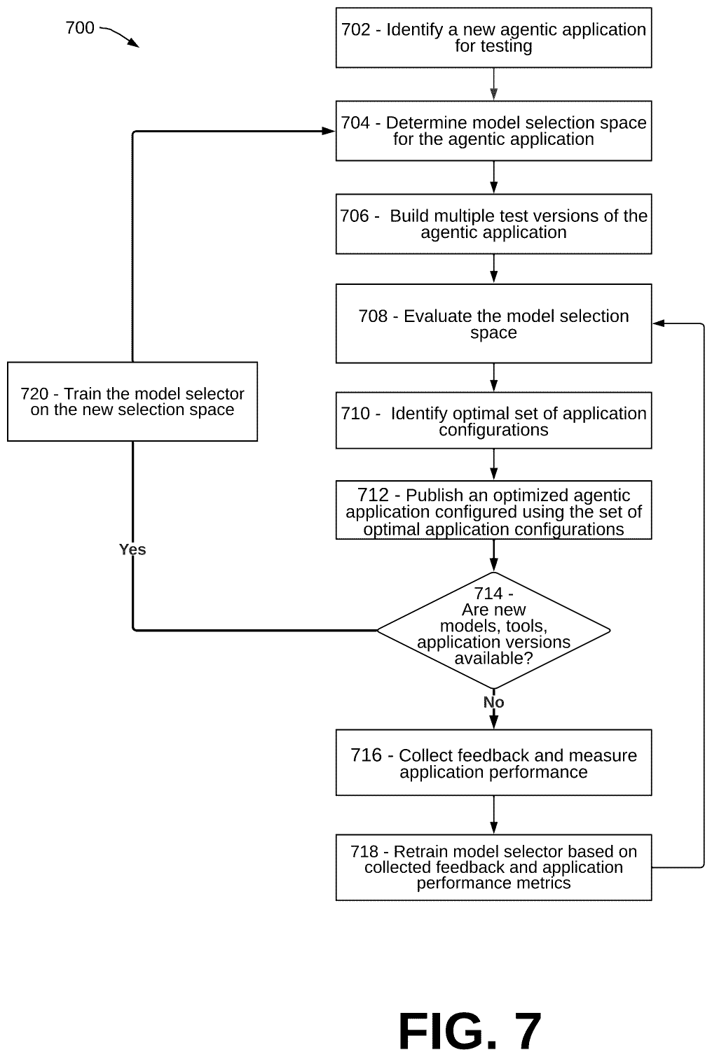

Some present examples also include methods. FIG. 7 is a block diagram of a process 700 of training an optimization system for an agentic application. In various embodiments, the optimization system may be trained to determine configurations for agentic applications that increase the accuracy and quality of responses generated by the agentic applications and improve the speed, compute efficiency, cost efficiency, and reliability of the agentic applications. At step 702, the generative systems may identify a new agentic application for testing. The new agentic application may be a newly built agentic application that has never been used in production and/or an updated version of an agentic application that has previously been deployed to a production environment.

At step 704, an optimization system may determine a model selection space for the identified agentic application. The size of the model selection space may depend on the number available language models that may be selected by the agentic application, number the tools included in the application, the number of configurable model parameters for each available model, and the amount of other application configurations. The model selection space may be determined by performing a grid search on the application configurations to determine all possible combinations of every application configuration. For example, the model selection space may include all possible combinations of available models and tools with each application configuration including a unique set of model selections for the tools. The multiple unique sets of application configurations for the agentic application identified by the grid search may be aggregated into the model selection space.

To reduce the number of combinations and increase the efficiency of the application configuration process, a constrained grid search may be performed to determine the model selection space. The constrained grid search may include a first grid search over a first subset of model selections having the same model selected for one or more sampled tool(s) and different models selected for the other tools (e.g., the non-sampled tools). The constrained grid search may also include a second grid search over a second subset of model selections having the same model selections for the non-sampled tools (e.g., the highest performing model selection for each non-sampled tool identified in the first gird search) and different models selected for the one or more sampled tools.

At step 706, the optimization system may build multiple test versions of the agentic application. Each test version of the agentic application may be configured using one of the unique sets of application configurations included in the model selection space.

At step 708, the optimization system may evaluate the model selection space using a sample of test cases. The model selection space may be evaluated by determining, for each test version of the agentic application, a performance score for a sample of test cases. The performance score may be determined based on a response generated by each particular test version of the agentic application to each request included in the sample of test cases. The performance score may be generated based on a response score that evaluates the content included in the responses generated by each test version of the agentic application and a technical score that evaluates the technical performance, based on one or more technical metrics, of each version of the agentic application during response generation. In various embodiments the technical score may be determined based on one or more technical metrics measured for each test version of the agentic application during generation of each response to a request in the sample of test cases.

A tuning module may also perform an optimization search to determine one or more tunable model parameters for one or more language models included in the optimal configurations. For example, the optimization search may be used to determine one or more tunable parameters of the selected models included in the first or second subsets. The trained tuning module may determine one or more optimal model parameters for the language models selected by the model selector. The optimization search may be, for example, a sequential model-based optimization search (SMBO) that trains a surrogate model using the performance scores for the different model configurations determined during the grid search. The trained surrogate model and an acquisition function may be used to determine the values for the tunable parameters to test during each grid search. The SMBO and gird search may be performed in parallel so that the model selector and tuning module may be trained together.

In various embodiments, the optimization search may comprise training a surrogate model based on multiple responses generated by the multiple test versions of the agentic application. Each of the multiple test versions of the application may include an application configuration that has a different value for one or more tunable model parameters. An acquisition function may be used to select a new value for the one or more tunable model parameters to test from a portion of a parameter space identified by the surrogate model.

At step 710, the optimization system may determine optimal application configurations for an agentic application using the model selector and tuning module. For example, the optimization system may identify an optimal set of application configurations for the agentic application based on the performance scores and/or optimal values for the tunable parameters. The optimal application configurations may include model selections and values for tunable model parameters that were determined based on an evaluation of different versions of the agentic application having different model selections and values for one or more model parameters (e.g., different application configurations). The optimal application configurations may be stored and retained for use in published versions of the agentic applications. At step 712, the optimization system may provide an optimized agentic application configured with the optimal set of application configurations for publication in a production environment.

At step 714, the optimization system may periodically check for updates to agentic applications and/or available language models. The optimization system may check for updates on a pre-determined schedule (e.g., daily, weekly, monthly, and the like) and/or in response to one or more triggers (e.g., updates to agentic applications pushed to one or more code repositories, new published versions of one or more available language models, measurement of an abnormality in one or more application performance metrics, increase in application usage, and the like). If one or more new models, tools, and/or versions of the agentic application are available (Yes at step 714), the optimization system may train the model selector and/or tuning module on the new model selection space. For example, the optimization system may add adding one or more new tools, language models, and/or applications to a list of available application configurations and perform a grid search on the updated list of available application configurations to generate an expanded model selection space at step 704. The optimization system may repeat steps 706-712 to train the model selector and/or tuning module to identify the optimal and/or production configurations for the agentic application from the expanded model selection space. For example, the model selector and/or tuning module may be trained to identify the optimal and/or production configurations for updated applications with new tools and/or determine optimal and/or production configurations that consider the updated available language models.

If no new models, tools, or application versions are available (No at step 714) the optimization system may collect feedback on responses generated by the optimized agentic application and measure the performance of the optimized agentic application during response generation. The collected feedback may be used to generate a sample graded examples for the optimized agentic applications. Each graded example in the sample of graded examples may include a request submitted to a published version of the optimized agentic application, a response to the request generated by the published version of optimized the agentic application, and a positive or negative grade for the response. The grade for the response may be determined based on at least one of user feedback collected for the response, a performance metric measured during generation of the response, and a user action observed by a publishing application (e.g., a publishing application that distributes advertising content online), the optimized agentic application, or other application connected to the optimized agentic application after the response was displayed to the user. For example, an action indicating the user was happy with the response generated by the optimized agentic application (e.g., clicking on an ad for a product recommended in a response, buying a plane ticket to a travel destination described in a response, asking a follow up question having a positive sentiment after receiving the response, and the like) may result in a positive grade for the response. An action indicating the user was not happy with the response generated by the optimized agentic application (e.g., closing the agentic application and opening another competing agentic application, asking a follow up question with a negative sentiment, buying a product that competes with a product recommended by the optimized agentic application, and the like) may result in a negative grade for the response.

The application evaluator may also measure one or more updated performance metrics for the published, optimized agentic applications during the generation of the responses included in the graded examples. At step 718, the model selector may be retrained on the collected feedback and/or application performance metrics by using the graded examples and updated performance metrics to determine the performance scores used to evaluate the model selection space at step 708 and repeating steps 710-712. The new production configurations determined in the retaining step(s) using the collected feedback and/or updated performance metrics may be retained for use in the agentic application. For example, the optimization system may replace the original optimal set of application configurations with the new production configurations and build a production version of the agentic application that may use the new production application configurations to generate responses to user requests. Steps 712-720 may be repeated continuously to retrain new iterations of the model selector over time. Each new iteration of the model selector may have an improved ability to determine configurations for agentic applications that improve the accuracy and quality of the responses generated by the application and the technical performance of the application during response generation.

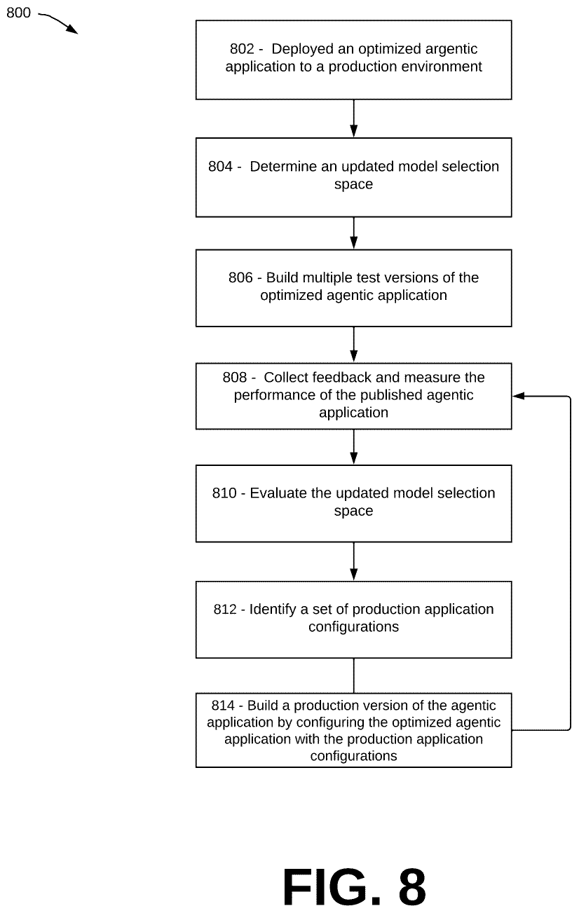

FIG. 8 is a block diagram illustrating a process 800 of using an optimization system to improve the performance of one or more agentic applications that are deployed in a production environment. The agentic application may include, for example, a marketing assistant that may help users perform marketing tasks within a marketing platform (e.g., a web application that may configure and run one or more media publishing campaigns). For example, the marketing assistant agentic application may help users with questions about how to use the marketing platform, assist users with tasks performed on the marketing platform (e.g., search for audiences of consumers having desired characteristics, create new email or display advertising marketing campaigns, and the like), and answer analytics queries about the performance of one or more campaigns running on the platform. The marketing assistant agentic application may include one or more tools that may help the assistant respond to user requests. The tools may include, for example, a generic language model that may answer general purpose questions and carry-on conversations with users, document search tools that may search one or more documents, text repositories, wikis, and the like to answer specific user questions, and one or more APIs that may interact with software tools and other components to perform tasks (e.g., analyze data, make predictions, draw insights, create or update campaigns, segment audiences, and the like) on the marketing platform.

The optimization system may improve the performance of an agentic application (e.g., the marketing assistant) deployed in a production environment by updating the optimal application configurations (e.g., the configurations determined using the process shown in FIG. 7) based on the performance of the agentic application (e.g., an optimal agentic application) in production. The optimization system may determine production application configurations that optimize the language models mappings for each tool (e.g., the language models selected to interact with each tool) and determine optimal values for the tunable parameters of each of the selected language models. To determine a set of production application configurations an optimized agentic application configured using a set optimal application configurations is published (e.g., deployed to a production environment) at step 802.

At step 804, the model selector may determine an updated model selection space using a genetic algorithm. The updated model space may include multiple variations of the optimal set of application configurations generated using the genetic algorithm. A genetic module may use the genetic algorithm to generate different versions of the optimal application configurations to test during retraining. For example, the genetic algorithm may create a genome that represents the optimal application configurations (e.g., an optimal genome), with each element in the genome representing a model selection for a tool included in the agentic application. The genetic algorithm may apply one or more genetic operators (e.g., replacement mutations, swap mutations, crossover mutations, and the like) to the optimal genome to generate a population of mutated genomes. In various embodiments, the updated model selection space may be determined using the genetic algorithm by mapping the set of optimal application configurations to a genome. The genome may include a genetic sequence of alpha numeric characters that represent the set of optimal application configurations. Each character in the genetic sequence may correspond to a configuration in the optimal application configurations. For example, each character may correspond to a unique model selection (e.g., a mapping between a tool included in the agentic application and an available language model selected to interact with the tool).

The genetic module may determine the multiple variations of the optimal application configurations by applying one or more genetic operators to the genome to generate a population of mutated genomes. Each mutated genome may include a unique sequence of characters representing the model selections (e.g. mappings) for each tool. The population of mutated genomes may include all of the possible combinations of model selections available for the agentic application. Each genome in the population of mutated genomes may be mapped to the available application configurations to transform the genetic sequences into a set of application configurations (e.g., one of the multiple variations of the optimal application configurations). Each of the multiple optimal application configurations generated from the population of mutated genomes may be aggregated to form the updated model selection space.

At 806, the optimization system may build multiple test versions of the optimized agentic application. Each test version of the optimized agentic application may be configured using one of the multiple variations of the optimal set of application configurations included in the model selection space. At step 808, the optimization system may collect feedback and measure the performance of the optimized agentic application after it is deployed to production. At step 810, the optimization system may evaluate the updated model selection space by determining a fitness score, efficiency score, and or composite fitness score for each test version of the optimized agentic application. For example, the performance of each application configuration may be tested on sample of graded examples to determine a fitness score for each mutated configuration. The graded examples may be determined using actual user requests submitted to a published version of the agentic application and user feedback received for the responses for the user requests generated by the published application. In various embodiments, the fitness score may be determined based on a response generated by each particular test version of the optimal agentic application to each request included in a sample of graded examples. The efficiency score may be determined based on one or more cosine similarity scores for the generated responses and/or one or more performance metrics measured for the response generation process.

Additional retraining steps may be performed by further varying the highest performing mutated genomes (e.g., the genomes with the highest fitness score) to create child genomes. Versions of the agentic application configured with child configurations represented by each child genome may be tested on the sample of graded examples to determine a fitness score for each child configuration. Additional retraining steps may be performed until the performance of the agentic application cannot be improved with additional retraining and/or a desired level of application performance is achieved.

At step 812, a set of production application configurations may be identified based on the fitness scores, efficiency scores, and/or composite fitness scores. The set of production configurations determined by the retained model selector may be retained for use in published optimized agentic applications. The production configurations may replace the optimal configurations and may be used by the published agentic application to generate responses to user requests. For example, the optimization system may build a production version of the agentic application by configuring the optimized agentic application with the production application configurations, at step 814.

To continuously refine the application configurations of the published agentic application, steps 808-814 may be repeated to update the production application configurations based on collected feedback and updated performance metrics. A refinement job may run on a predetermined schedule (e.g., daily, weekly, monthly, and the like) to retrain the model selector based on the collected feedback and/or updated performance metrics. The retrained model selector may determine production configurations that optimize the performance of the published agentic application against the collected user feedback. Application users and the tasks users are asking the agentic applications to perform are constantly evolving. Continuously refining the application configurations ensures the agentic application is optimized to deliver an engaging and helpful user experience, generate accurate, high-quality responses to user requests, and operate efficiency and reliably to improve technical performance and availability and reduce compute costs.

In this disclosure, the following definitions may apply in context. A “Client Device” or “Electronic Device” refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Communications Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” (also referred to as a “module”) refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component includes a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Image data” in this context refers to any type of visual media or other data that includes a number of rows and columns or pixels including, for example, images, frames of video, three dimensional holograms, pixel data, virtual reality (VR) content, augmented reality (AR) content, mixed reality (MR) content, extended reality (XR) content, and the like.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“Processor” refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. An optimization system for agentic applications, the optimization system comprising:
one or more processors; and
a memory storing instructions that, when executed by at least one processor in the one or more processors, cause the at least one processor to perform operations comprising:
performing a grid search on multiple application configurations to determine a model selection space for an agentic application, the model selection space including multiple unique sets of application configurations for the agentic application;
building multiple test versions of the agentic application, each test version of the agentic application configured using one of the unique sets of application configurations;
evaluating the model selection space by determining, for each test version of the agentic application, a performance score for a sample of test cases, the performance score determined based on a response generated by each particular test version of the agentic application to each request included in the sample of test cases;
identifying an optimal set of application configurations for the agentic application based on the performance scores; and
providing an optimized agentic application configured with the optimal set of application configurations for publication in a production environment.

2. The optimization system of claim 1, wherein the operations further comprise determining an updated model selection space by generating multiple variations of the optimal set of application configurations using a genetic algorithm;
building multiple test versions of the optimized agentic application, each test version of the optimized agentic application configured using one of the multiple variations of the optimal set of application configurations;
evaluating the updated model selection space by determining a fitness score for each test version of the optimized agentic application, the fitness score determined based on a response generated by each particular test version of the optimal agentic application to each request included in a sample of graded examples;
identifying a set of production application configurations based on the fitness scores; and
building a production version of the agentic application by configuring the optimized agentic application with the production application configurations.

3. The system of claim 2, wherein the updated model selection space is determined using the genetic algorithm by:
mapping the set of optimal application configurations to a genome, the genome including a genetic sequence of alpha numeric characters that represent the set of optimal application configurations, each character in the genetic sequence corresponding to a configuration in the optimal application configurations;
determining the multiple variations of the optimal application configurations by applying one or more genetic operators to the genome to generate a population of mutated genomes and mapping each mutated genome in the population of mutated genomes to a set of application configurations; and
aggregating the multiple variations of the optimal application configurations in the updated model selection space.

4. The system of claim 3, wherein the genetic sequence includes a number of characters equal to a number of tools used by the agentic application and each character in the number of characters corresponds to language model selected to interact with a tool in the number of tools.

5. The system of claim 3, wherein the one or more genetic operators include at least one of a swap mutation, a crossover mutation, and a replacement mutation.

6. The system of claim 2, wherein each graded example in the sample of graded examples includes a request submitted to a published version of the agentic application, a response to the request generated by the published version of the agentic application, and a positive or negative grade for the response.

7. The system of claim 6, wherein the grade for the response may be determined based on at least one of user feedback collected for the response, a performance metric measured during generation of the response, and a user action observed after the response was displayed to the user.

8. The system of claim 1, wherein the operations further comprise performing an optimization search in parallel with the grid search to determine one or more tunable model parameters for one or more language models included in the optimal configurations.

9. The system of claim 8, wherein the optimization search comprises training a surrogate model based on multiple responses generated by the multiple test versions of the agentic application, each of the multiple test versions of the application including an application configuration that has a different value for one or more tunable model parameters; and
using an acquisition function to select a new value for the one or more tunable model parameters to test from a portion of a parameter space identified by the surrogate model.

10. The system of claim 1, wherein determining the performance score comprises determining, for each test version of the agentic application, a technical score for the sample of test cases, the technical score determined based on one or more technical metrics measured for each test version of the agentic application during generation of each response to a request in the sample of test cases.

11. A method of optimizing agentic applications, the method comprising:
performing a grid search on multiple application configurations to determine a model selection space for an agentic application, the model selection space including multiple unique sets of application configurations for the agentic application;
building multiple test versions of the agentic application, each test version of the agentic application configured using one of the unique sets of application configurations;
evaluating the model selection space by determining, for each test version of the agentic application, a performance score for a sample of test cases, the performance score determined based on a response generated by each particular test version of the agentic application to each request included in the sample of test cases;
identifying an optimal set of application configurations for the agentic application based on the performance scores; and
providing an optimized agentic application configured with the optimal set of application configurations for publication in a production environment.

12. The method claim 11, further comprising determining an updated model selection space by generating multiple variations of the optimal set of application configurations using a genetic algorithm;
building multiple test versions of the optimized agentic application, each test version of the optimized agentic application configured using one of the multiple variations of the optimal set of application configurations;
evaluating the updated model selection space by determining a fitness score for each test version of the optimized agentic application, the fitness score determined based on a response generated by each particular test version of the optimized agentic application to each request included in a sample of graded examples;
identifying a set of production application configurations based on the fitness scores; and
building a production version of the agentic application by configuring the optimized version of the agentic application with the production application configurations.

13. The method of claim 12, wherein the updated model selection space is determined using the genetic algorithm by:
mapping the set of optimal application configurations to a genome, the genome including a genetic sequence of alpha numeric characters that represent the set of optimal application configurations, each character in the genetic sequence corresponding to a configuration in the optimal application configurations;
determining the multiple variations of the optimal application configurations by applying one or more genetic operators to the genome to generate a population of mutated genomes and mapping each mutated genome in the population of mutated genomes to a set of application configurations; and
aggregating the multiple variations of the optimal application configurations in the updated model selection space.

14. The method of claim 13, wherein the genetic sequence includes a number of characters equal to a number of tools used by the agentic application and each character in the number of characters corresponds to language model selected to interact with a tool in the number of tools.

15. The method of claim 13, wherein the one or more genetic operators include at least one of a swap mutation, a crossover mutation, and a replacement mutation.

16. The method of claim 12, wherein each graded example in the sample of graded examples includes a request submitted to a published version of the agentic application, a response to the request generated by the published version of the agentic application, and a positive or negative grade for the response.

17. The method of claim 16, wherein the grade for the response may be determined based on at least one of user feedback collected for the response, a performance metric measured during generation of the response, and a user action observed after the response was displayed to the user.

18. The method of claim 11, wherein the further comprising performing an optimization search in parallel with the grid search to determine one or more tunable model parameters for one or more language models included in the optimal configurations.

19. The method of claim 18, wherein the optimization search comprises training a surrogate model based on multiple responses generated by the multiple test versions of the agentic application, each of the multiple test versions of the application including an application configuration that has a different value for one or more tunable model parameters; and
using an acquisition function to select a new value for the one or more tunable model parameters to test from a portion of a parameter space identified by the surrogate model.

20. The method of claim 11, wherein determining the performance score further comprises determining, for each test version of the agentic application, a technical score for the sample of test cases, the technical score determined based on one or more technical metrics measured for each test version of the agentic application during generation of each response to a request in the sample of test cases.
